(19) United States
(12) Patent Application Publication
(10) Pub. No.: US 2026/0113533 A1
(43) Pub. Date: Apr. 23, 2026

(54) IMAGING APPARATUS

(71) Applicant: CANON KABUSHIKI KAISHA, Tokyo (JP)

(72) Inventor: KAORI MIYOSHI, Tokyo (JP)

(21) Appl. No.: 19/355,894

(22) Filed: Oct. 10, 2025

(30) Foreign Application Priority Data
Oct. 21, 2024 (JP) 2024-184711

(51) Int. Cl. H04N 23/65; H04N 23/53; H04N 23/55; H04N 23/68

(52) U.S. Cl. CPC H04N 23/651; H04N 23/53; H04N 23/55; H04N 23/687

(57) ABSTRACT

An imaging apparatus includes a main body, an imaging unit, a support unit configured to support the imaging unit, a driving unit configured to drive the imaging unit to rotate with respect to the main body, a memory storing instructions, and a processor executing the instructions causing the imaging apparatus to determine whether the imaging unit is in a non-use state, control, in a case where termination of imaging is instructed, the driving unit to drive the imaging unit to be in a first position, and perform control, in a case where it is determined that the imaging unit is in a non-use state, to shut off power supply.

### BACKGROUND

### Field of the Technology

The present disclosure relates to an imaging apparatus.

### Description of the Related Art

Conventionally, in a gimbal-integrated camera that rotatably drives a camera unit, the camera unit is supported by a plurality of support units that connects a plurality of driving devices. When such a gimbal-integrated camera is powered off, the driving devices are not energized and thus the plurality of support units connected to a grip portion and the camera are not fixed and unstable. If the camera unit and the support units protrude from the grip portion, the camera is unsuitable for portable use.

U.S. Patent Application Publication No. 2019/0230289 describes a technique, in which, in a case where a power-off instruction is provided, the gimbal is driven to a folded position, maintained in that position for a predetermined period of time, and then powered off.

### SUMMARY

According to an aspect of the present disclosure, an imaging apparatus includes a main body, an imaging unit, a support unit configured to support the imaging unit, a driving unit configured to drive the imaging unit to rotate with respect to the main body, a memory storing instructions, and a processor executing the instructions causing the imaging apparatus to determine whether the imaging unit is in a non-use state, control, in a case where termination of imaging is instructed, the driving unit to drive the imaging unit to be in a first position, and perform control, in a case where it is determined that the imaging unit is in a non-use state, to shut off power supply.

Features of the present disclosure will become apparent from the following description of embodiments with reference to the attached drawings. The following description of embodiments is described by way of example.

### BRIEF DESCRIPTION OF THE DRAWINGS

FIG. 1 is a perspective view illustrating an outer appearance of a gimbal-integrated camera, which is an example of an imaging apparatus according to an embodiment.

FIG. 2 is a block diagram illustrating part of the gimbal-integrated camera according to the embodiment.

FIG. 3 is a cross-sectional view illustrating three driving devices according to the embodiment.

FIG. 4 is a perspective view illustrating a stored posture of the gimbal-integrated camera according to the embodiment.

FIG. 5 is a perspective view illustrating a state where the gimbal-integrated camera is housed in a case according to the embodiment.

FIG. 6 is a flowchart illustrating the flow of a power-off step according to the embodiment.

FIG. 7 is a flowchart illustrating the flow of a non-use state determination step according to the embodiment.

FIG. 8 is a perspective view illustrating the gimbal-integrated camera according to another embodiment.

FIG. 9 is a flowchart illustrating the flow of a power-off step according to the embodiment.

### DESCRIPTION OF THE EMBODIMENTS

Embodiments of the present disclosure will be described in detail below with reference to the attached drawings.

### First Embodiment

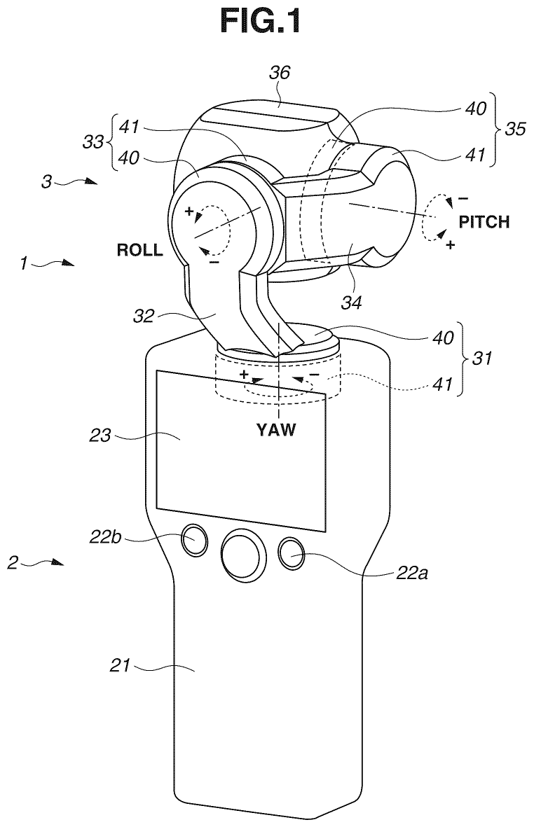

FIG. 1 is a perspective view illustrating a configuration of a gimbal-integrated camera as an example of an imaging apparatus according to a first embodiment of the present disclosure.

A gimbal-integrated camera 1 includes a main body unit 2 and an anti-vibration mechanism 3. The main body unit 2 includes a housing 21. The housing 21 also serves as a grip portion for a user to hold when performing shooting, and is provided with a first operation unit 22a, a second operation unit 22b, and a display unit 23. The housing 21 is also equipped with a plurality of input units, an external media slot, a tripod mount, a strap, external input/output terminals, a power supply terminal, a tally lamp, a microphone, and a speaker, which are not illustrated.

The anti-vibration mechanism 3 includes a first driving unit 31, a first support member 32, a second driving unit 33, a second support member 34, and a third driving unit 35. The first support member 32 is pivotally coupled to the housing 21 of the main body unit 2 via the first driving unit 31, and the second support member 34 is pivotally coupled to the first support member 32 via the second driving unit 33. A camera unit 36 is pivotally coupled to the second support member 34 via the third driving unit 35.

In the present embodiment, the rotation axis of the first driving unit 31 is defined as YAW, the rotation axis of the second driving unit 33 is defined as ROLL, and the rotation axis of the third driving unit 35 is defined as PITCH. Additionally, the angle of each rotation axis is defined as 0° in a case where the anti-vibration mechanism 3 is in a state illustrated in FIG. 1. The amount of rotation and the direction of rotation are represented using the positive and negative signs illustrated in FIG. 1.

The first support member 32 is fixed to the first driving unit 31 and the second driving unit 33 with screws, which are not illustrated. Similarly, the second support member 34 is fixed to the second driving unit 33 and the third driving unit 35 with screws, which are not illustrated. A method of fixing each driving unit may be a bonding method. Cable paths, which are not illustrated, are formed in the respective movable parts and support members, where power supply cables are routed through the cable paths.

In the present embodiment, the first driving unit 31, the second driving unit 33, and the third driving unit 35 are outer three-phase brushless motors, each of which includes a rotor unit 40 and a stator unit 41. In the present embodiment, the rotor units 40 and the stator units 41 of the first driving unit 31, the second driving unit 33, and the third driving unit 35 have identical configurations, but the motors may have different configurations and different sizes. Alternatively, the first driving unit 31, the second driving unit 33, the third driving unit 35 may be inner type motors or axial gap motors.

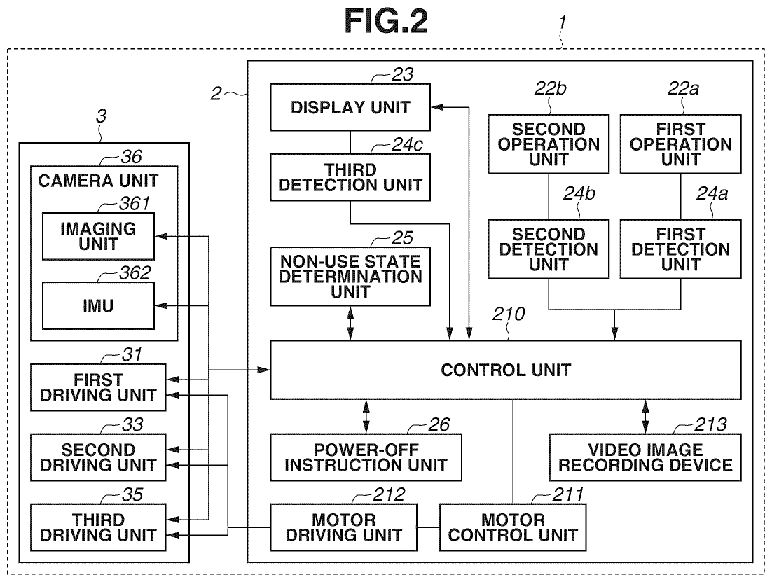

FIG. 2 is a block diagram illustrating part of the system of the gimbal-integrated camera 1 according to the present embodiment. The main body unit 2 includes a control unit 210 for controlling the gimbal-integrated camera 1, a motor control unit 211, and a motor driving unit 212. The control unit 210 issues various types of trigger events in response to detection by a first detection unit 24a, a second detection unit 24b, a non-use state determination unit 25, and the like.

The first detection unit 24a detects the first operation unit 22a being pressed by the user and notifies the control unit 210 of the detection. Similarly, the second detection unit 24b detects the second operation unit 22b being pressed by the user and notifies the control unit 210 of the detection.

In the present embodiment, a static capacitance touch panel is used in the display unit 23. The display unit 23 is connected to the control unit 210, and displays video images captured by the camera unit 36, settings of the gimbal-integrated camera 1, and the state of the gimbal-integrated camera 1. A third detection unit 24c detects a touch operation performed on the display unit 23, and the control unit 210 issues various types of trigger events based on a detection signal from the third detection unit 24c.

The non-use state determination unit 25 determines that the gimbal-integrated camera 1 is in a state of not being used by the user, and notifies the control unit 210 of the determination. A power-off instruction unit 26 issues a power-off trigger to shut off the power supply to the motor in the first driving unit 31, the second driving unit 33, and the third driving unit 35 based on a determination condition, which will be described below, and notifies the control unit 210 of the power-off trigger.

The motor control unit 211 generates a switching signal based on information that indicates an absolute angle of each of the first driving unit 31, the second driving unit 33, and the third driving unit 35, which is input to the control unit 210. The motor driving unit 212 is an inverter circuit, and includes six switching elements for each motor. The switching elements are not illustrated. The motor driving unit 212 then performs switching based on the switching signal generated by the motor control unit 211 to generate three-phase alternating-current power. The generated alternating-current power is supplied to the first driving unit 31, the second driving unit 33, and the third driving unit 35 via cables, which are not illustrated.

The camera unit 36 includes an imaging unit 361 and an inertial measurement unit (IMU) 362. The imaging unit 361 includes an image pickup element, an optical element, an auto focus (AF) mechanism, an aperture stop mechanism, a neutral density (ND) mechanism and the like, which are not illustrated. A video image or an image captured by the camera unit 36 is transmitted to the control unit 210, converted into video image data or image data, and stored in a video image recording device 213, which includes a memory and the like. The IMU 362 includes an angular velocity sensor capable of detecting angular velocity in three axis directions and an acceleration sensor that detect acceleration in the three axis directions. The angular velocity sensor and the acceleration sensor are not illustrated.

The control unit 210 calculates an amount of shake based on a detection value obtained by the IMU 362, and performs a vibration suppression operation by driving the camera unit 36 in the YAW, ROLL, and PITCH directions via the first driving unit 31, the second driving unit 33, and the third driving unit 35, respectively, based on the calculated amount of shake. The control unit 210 can perform drive control on the first driving unit 31, the second driving unit 33, and the third driving unit 35 not only for vibration suppression, but also for the purpose of intentionally changing the imaging angle of the camera unit 36.

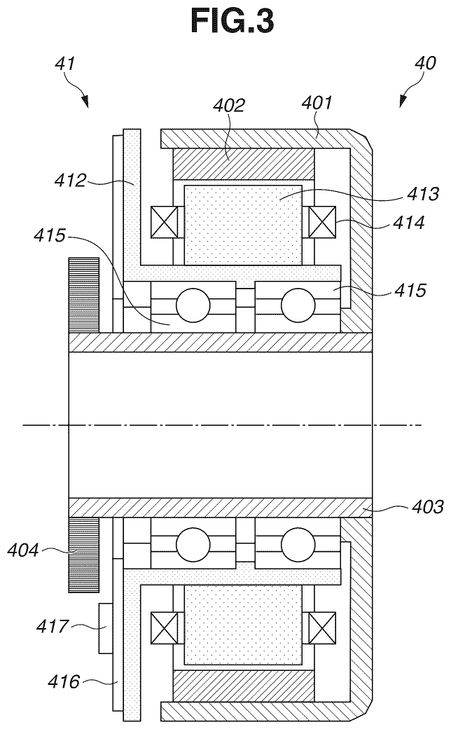

FIG. 3 is a diagram illustrating the configuration of the rotor unit 40 and the stator unit 41 that constitute the first driving unit 31, the second driving unit 33, and the third driving unit 35.

The rotor unit 40 includes a yoke 401, a driving magnet 402, a rotation shaft 403, and a detection magnet 404. The rotation shaft 403 is a hollow shaft, and enables a cable, which is not illustrated, to pass therethrough. The detection magnet 404 is magnetized with two poles in the radial direction in the present embodiment, but may be magnetized with multiple poles of more than two poles.

The stator unit 41 includes a base 412, a core 413, a coil 414, a bearing 415, an electronic circuit board 416, and an angle sensor 417. The electronic circuit board 416 includes the angle sensor 417. The electronic circuit board 416 is electrically connected to the control unit 210. In the present embodiment, the angle sensor 417 includes two Hall elements, an angle calculation unit, and a communication unit in a single package. The Hall elements, the angle calculation unit, and the communication unit are not illustrated.

The angle sensor 417 detects a leakage magnetic flux of the detection magnet 404. Specifically, the angle sensor 417 detects a magnetic flux Br in a radial direction and detecting a magnetic flux Bt in a tangent line direction. The detected magnetic flux forms a sine wave and a cosine wave. The angle calculation unit calculates an arctangent value based on the sine wave and the cosine wave to obtain an absolute angle and transmits the absolute angle to the control unit 210. The angle sensor 417 may be a sensor that does not include the angle calculation unit or the communication unit, and instead use a plurality of Hall elements and a plurality of linear Hall sensors.

The angle sensor 417 may be configured to detect the leakage magnetic flux of the driving magnet 402 without using the detection magnet 404.

The orientation and movable range of the gimbal-integrated camera 1 according to the present embodiment will now be described. As described above, the control unit 210 performs drive control on the first driving unit 31, the second driving unit 33, and the third driving unit 35 in the anti-vibration mechanism 3, thereby changing the orientation of the camera unit 36.

In the present embodiment, a state where the rotation shafts of the first driving unit 31, the second driving unit 33, and the third driving unit 35 are each at an angle of 0°, as illustrated in FIG. 1, is defined as a normal position. The normal position refers to the orientation of the camera unit 36 used when the user performs normal shooting. The user typically holds the gimbal-integrated camera 1 so that the display unit 23 faces the user to check the video image displayed in the display unit 23 while performing shooting. In a case of capturing a scene such as landscape shooting in this state, the lens surface 36a of the camera unit 36 faces a direction opposite to the user.

An adjustment is performed so that the rotation shafts of the first driving unit 31, the second driving unit 33, and the third driving unit 35 are each at an angle of 0°. The angles of the rotation shafts are each adjusted to 0° based on information about the orientation of the camera unit 36 and the captured video images. The control ranges of the first driving unit 31, the second driving unit 33, and the third driving unit 35 are set based on drive control and mechanical restrictions.

The drive control range of the first driving unit 31 is set from −70° to +230°, the drive control range of the second driving unit 33 is set from −45° to +45°, and the drive control range of the third driving unit 35 is set from −50° to +100°. The mechanical movable range of the first driving unit 31 is set from −90° to +250°, the mechanical movable range of the second driving unit 33 is set from −90° to +90°, and the mechanical movable range of the third driving unit 35 is set from −90° to +180°.

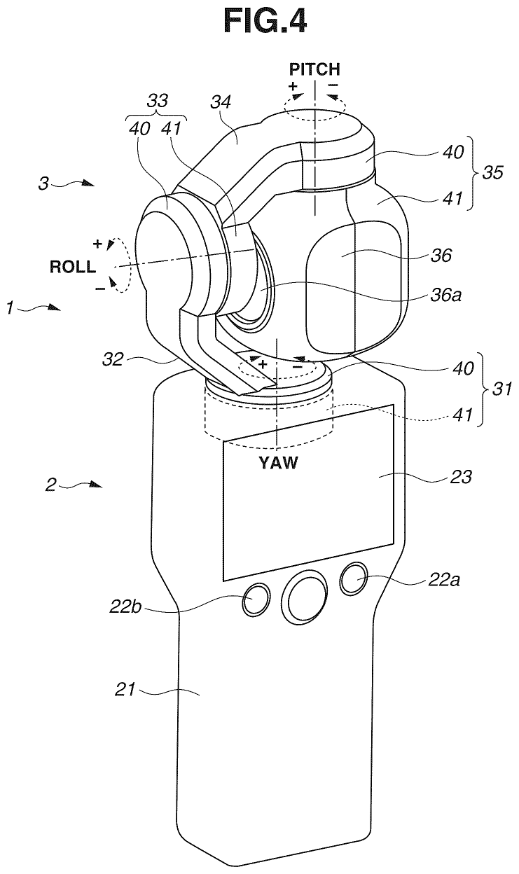

FIG. 4 is a perspective view illustrating a stored posture in which the gimbal-integrated camera 1 can be stored in a housing case 5. In the present embodiment, the stored posture is a state which the first driving unit 31 is rotated by +90° from the normal position, the second driving unit 33 is rotated by +90° from the normal position, and the third driving unit 35 is rotated by +180° from the normal position. The stored posture is not limited to these angles. For example, the first driving unit 31 may be rotated to −90° and the third driving unit 35 may be rotated to 0°.

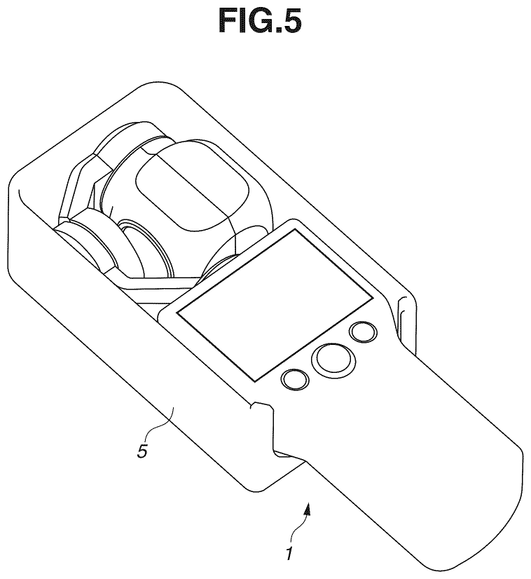

FIG. 5 is a perspective view illustrating a state where the gimbal-integrated camera 1 is housed in the housing case 5 by the user. The housing case 5 is formed of a deformable resin material. The inner wall surface of the housing case 5 is formed in a shape corresponding to the outer profile of the gimbal-integrated camera 1, and has a structure that fits with a part of the gimbal-integrated camera 1. The inner portion of the housing case 5 is shaped to cover at least the periphery of the anti-vibration mechanism 3, which makes it possible to protect the gimbal-integrated camera 1 from getting damaged or scratched in a case where the gimbal-integrated camera 1 is carried or similar cases.

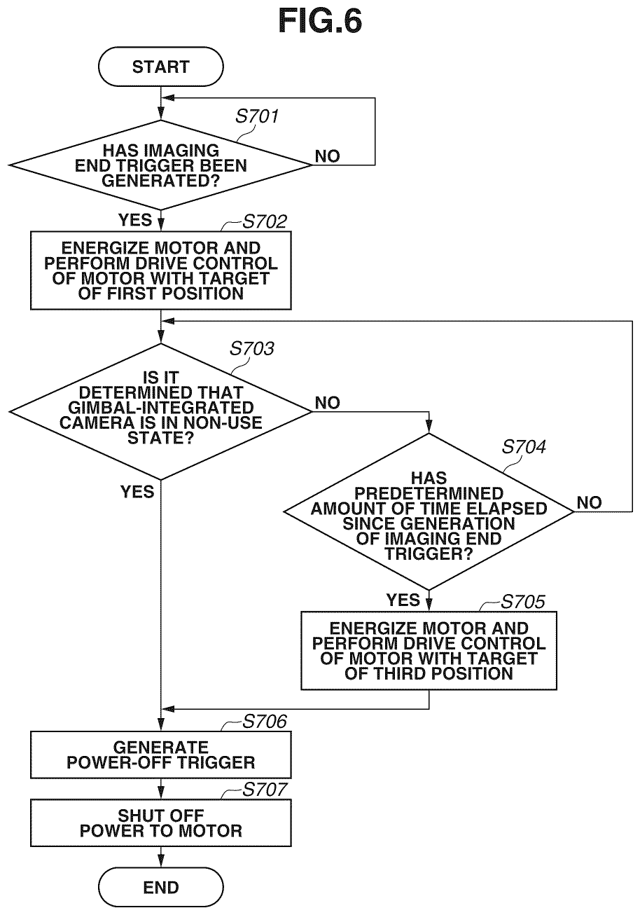

A description will now be provided of processing to be performed in a case where the user ends an imaging operation and performs an operation of powering off the gimbal-integrated camera 1 with reference to FIG. 6. FIG. 6 is a flowchart illustrating a step of powering off the gimbal-integrated camera 1. The flowchart in FIG. 6 is executed under the control of the control unit 210.

In step S701, the control unit 210 determines whether an imaging end trigger has been generated. When the user operates the first operation unit 22a to end the imaging operation of the gimbal-integrated camera 1, the first detection unit 24a notifies the control unit 210 of the operation. Alternatively, when the user operates the display unit 23 to terminate the imaging operation, the third detection unit 24c notifies the control unit 210 of the operation.

In a case of being notified of any of the above-mentioned operations, the control unit 210 generates an imaging end trigger. The imaging end trigger may be a trigger generated by an operation other than the operation performed using the first operation unit 22a or the display unit 23. In a case where the control unit 210 determines that the imaging end trigger has been generated (YES in step 701), the processing proceeds to step S702. In a case of determining that the imaging end trigger has not been generated (NO in step 701), the control unit 210 repeats the determination in step S701.

In step S702, the control unit 210 performs drive control on each of the motors, i.e., the first driving unit 31, the second driving unit 33, and the third driving unit 35, until the gimbal-integrated camera 1 reaches a first position corresponding to the stored posture illustrated in FIG. 4, and then the processing proceeds to step S703.

In step S703, the non-use state determination unit 25 determines that the gimbal-integrated camera 1 is in a state of being used by the user (in a use state). In a case where the non-use state determination unit 25 determines that the gimbal-integrated camera 1 is in a state of not being used by the user (in a non-use state) (YES in step S703), the processing proceeds to step S706. In a case where the non-use state determination unit 25 determines that the gimbal-integrated camera 1 is in the use state (NO in step S703), the processing proceeds to step S704.

In step S704, the control unit 210 determines whether a predetermined amount of time has elapsed since the generation of the imaging end trigger. The determination processing is processing to determine whether the user is in a preparation stage for use. In a case where the predetermined amount of time has not elapsed since the generation of the imaging end trigger (NO in step S704), the processing returns to step S703. In a case where the predetermined amount of time has elapsed since the generation of the imaging end trigger (YES in step S704), the control unit 210 determines that the user is in a preparation stage for use, and then the processing proceeds to step S705.

In step S705, the control unit 210 performs drive control on each of the motors, i.e., the first driving unit 31, the second driving unit 33, and the third driving unit 35 until the gimbal-integrated camera 1 reaches a third position, which corresponds to the normal position (the position where the user uses the gimbal-integrated camera 1 during normal shooting), and then the processing proceeds step S706.

In step S706, the power-off instruction unit 26 generates a power-off trigger to shut off the power supply to each of the motors, i.e., the first driving unit 31, the second driving unit 33, and the third driving unit 35, and then the processing proceeds step S707.

In step S707, the control unit 210 shuts off the power supply to each motor, and ends the processing.

The control unit 210 shuts off the power supply to the motors even in a case of determining that the user is in a preparation stage for use in step S704 and bringing the gimbal-integrated camera 1 to the normal position in step S705 because continuous supply of power to each motor leads to consumption of wasted power. Thus, after the elapse of the predetermined amount of time, the control unit 210 performs control to shut off the power supply to each motor even if the gimbal-integrated camera 1 is in a stand-by orientation in the preparation stage for use.

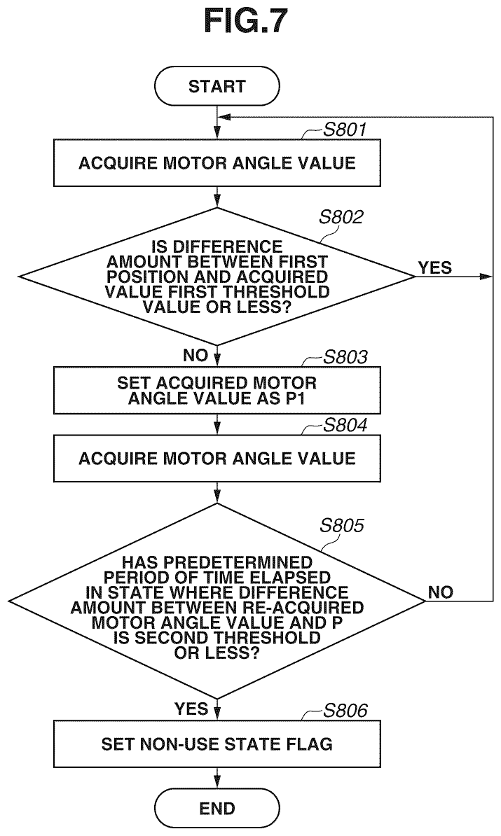

A description will now be provided of processing of determining whether the gimbal-integrated camera 1 is in the non-use sate in the above-mentioned step S703 in FIG. 6 with reference to FIG. 7.

In step S801, each of the motors, i.e., the first driving unit 31, the second driving unit 33, and the third driving unit 35, is energized until the gimbal-integrated camera 1 reaches the first position, which corresponds to the stored posture illustrated in FIG. 4. During the energization, the non-use state determination unit 25 acquires a motor angle value from the angle sensor 417 provided in each of the first driving unit 31, the second driving unit 33, and the third driving unit 35.

In step S802, it is determined whether a difference amount between the motor angle value acquired in step S801 and the first position is a first threshold value or less. In a case where a difference amount between the acquired motor angle value and the first position is the first threshold value or less (YES in step S802), it is determined that each driving unit in the gimbal-integrated camera 1 is in a controllable state, and then the processing returns to step S801.

It is desirable to set the first threshold value, for example, at a value that is slightly larger than a stop error that can occur in the anti-vibration mechanism 3 under conditions where neither especially large external force nor especially large disturbance is acting. If the user stores the gimbal-integrated camera 1 in the housing case 5 or places the gimbal-integrated camera 1 on a table after performing a power-off operation, external force acts on the anti-vibration mechanism 3, which brings the anti-vibration mechanism 3 into an uncontrollable state. Therefore, if each driving unit of the anti-vibration mechanism 3 can be controlled to rotate to the first position, it is determined that the user is still holding the housing 21 of the gimbal-integrated camera 1 and using the camera.

In a case where the difference amount between the acquired motor angle value and the first position is greater than the first threshold value (NO in step S802), it is determined that the gimbal-integrated camera 1 has become uncontrollable due to an external force applied to the anti-vibration mechanism 3, such as when the gimbal-integrated camera 1 is stored in the housing case 5 or other factors, and then the processing proceeds to step S803. It is assumed that the anti-vibration mechanism 3 is in a second position at this time. For example, the angle sensors 417 of the motors detect that the motor angle value of the first driving unit 31 is +87°, that of the second driving unit 33 is +88°, and that of the third driving unit 35 is +177°, respectively.

In step S803, the motor angle value detected by each of the angle sensors 417 is stored as P1, and then the processing proceeds step to S804.

In step S804, the non-use state determination unit 25 acquires a motor angle value from each of the angle sensors 417 again, and then the processing proceeds to step S805.

In step S805, it is determined whether the gimbal-integrated camera 1 is in the non-use state, for example, when the user has stored the camera in the housing case 5 and has continued to leave it unattended. Thus, it is determined whether a difference amount between the re-acquired motor angle value and the stored motor angle value P1 is a second threshold value or less. When a predetermined period of time has elapsed in a state where the difference amount is the second threshold value or less (YES in step S805), the processing proceeds step S806. It is desirable to set the second threshold value at a very small value (specifically, ±0.5 degrees or less).

In step S806, the non-use state determination unit 25 sets a non-use state flag, and thereafter the series of processing ends.

The above-mentioned flowchart from step S801 to step S806 in FIG. 7 is details of processing of determining whether the gimbal-integrated camera 1 is in the non-state state in step S703 in FIG. 6.

As described above, according to the present embodiment, it is possible to determine whether the gimbal-integrated camera 1 is in the non-use state without providing a special mechanical mechanism. Additionally, control is performed to maintain the stored posture in which the gimbal-integrated camera 1 is stored in the housing case 5 until it is determined that the gimbal-integrated camera 1 is in the non-use state. This control enables the user to immediately store the gimbal-integrated camera 1 in the housing case 5. Therefore, the gimbal-integrated camera 1 is more user-friendly than a gimbal that shuts off power after elapse of a predetermined period of time following a power-off instruction and can no longer maintain the folded position. In addition, a conventional gimbal that shuts off power after a predetermined period of time following a power-off instruction continues to supply power until that time elapses, even if it does not need to remain in a folded state. However, according to the present embodiment, by shutting off the power supply to the motors of each driving unit in a case where it is determined that the gimbal-integrated camera 1 is in the non-use state, it is possible to reduce power consumption.

### Second Embodiment

Control of the gimbal-integrated camera 1 according to a second embodiment will be now described. Since a basic configuration of the gimbal-integrated camera 1 is similar to that according to the first embodiment, a description of a configuration identical to that in the first embodiment is omitted.

The second embodiment is different from the first embodiment in the method of determining the non-use state in step S703 in FIG. 6. More specifically, the non-use state determination unit 25 determines whether the gimbal-integrated camera 1 is in the non-use state depending on an operation state of the first operation unit 22a, the second operation unit 22b, or the like. Specifically, in a case where the second detection unit 24b detects in step S701 that the user has operated the second operation unit 22b after operating the first operation unit 22a to end the imaging operation, the non-use state determination unit 25 determines that the gimbal-integrated camera 1 is in the non-use state.

The non-use state determination unit 25 may determine that the gimbal-integrated camera 1 is in the non-use state in a case where the user has performed, after performing the first operation on the first operation unit 22a, the second operation on the first operation unit 22a to terminate the imaging operation. The non-use state determination unit 25 may also determine that the gimbal-integrated camera 1 is in the non-use state in a case where the user has operated the display unit 23 after operating the first operation unit 22a to terminate the imaging operation.

The above description has been provided of an example in which the user performs the operation clearly indicating that the gimbal-integrated camera 1 is in the non-use state subsequently to issuing the instruction to terminate the imaging operation according to the second embodiment. This makes it possible to clearly distinguish whether the user intends to resume the imaging operation after temporarily terminating it, or to discontinue the use of the gimbal-integrated camera 1, and to select whether to maintain the stored posture of the gimbal-integrated camera 1.

### Third Embodiment

Control of the gimbal-integrated camera 1 according to a third embodiment will now be described. In the present embodiment, a basic configuration of the gimbal-integrated camera 1 is similar to that according to the first embodiment, and thus a description of a configuration identical to that in the first embodiment is omitted.

The third embodiment is different from the first embodiment in the method of determining the non-use state in step S703 in FIG. 6. More specifically, in step S701, the first detection unit 24a detects that the user has performed the first operation to start pressing the first operation unit 22a to terminate the imaging operation. It is assumed that the first detection unit 24a has detected the second operation in which the user releases the hand to end the pressing of the first operation unit 22a. In this case, the non-use state determination unit 25 determines that the gimbal-integrated camera 1 is in the non-use state.

That is, in a case where the user wants to maintain the gimbal-integrated camera 1 in the stored posture, the user keeps pressing the first operation unit 22a to energize each motor so that the gimbal-integrated camera 1 is maintained in the stored posture. Thereafter, in a case where the first operation unit 22a is no longer pressed, for example of a result of the user storing the gimbal-integrated camera 1 in the housing case 5 or other factors, the non-use state determination unit 25 determines that the gimbal-integrated camera 1 is in the non-use state, and the energization of each motor is stopped.

In a case where the user operates the second operation unit 22b or the display unit 23 to terminate the imaging operation, the non-use state determination unit 25 may determine that the gimbal-integrated camera 1 is in the non-use state upon detecting that the second operation unit 22b or the display unit 23 are no longer being pressed.

According to the present embodiment, it is possible for the user to select whether to maintain the stored posture of the gimbal-integrated camera 1 after issuing the instruction to terminate the imaging operation, similarly to the second embodiment.

### Fourth Embodiment

Control of the gimbal-integrated camera 1 according to a fourth embodiment will now be described. Since a basic configuration of the gimbal-integrated camera 1 is similar to that according to the first embodiment, a description of a configuration identical to that in the first embodiment is omitted.

The fourth embodiment is different from the first embodiment in the method of determining the non-use state in step S703 in the power-off control described in FIG. 6. More specifically, the non-use state determination unit 25 determines that the gimbal-integrated camera 1 is in the non-use state based on information acquired by the image pickup element in the imaging unit 361. Specifically, changes in luminance information or captured images obtained by the image sensor are detected, in comparison with respect to the imaging state of the image pickup element at the time of the generation of the imaging end trigger in step S701, in a case where the user stores the gimbal-integrated camera 1 in the housing case 5.

According to the present embodiment, it is possible to determine whether the gimbal-integrated camera 1 is in the non-use state using information acquired by the image pickup element after the end of imaging.

### Fifth Embodiment

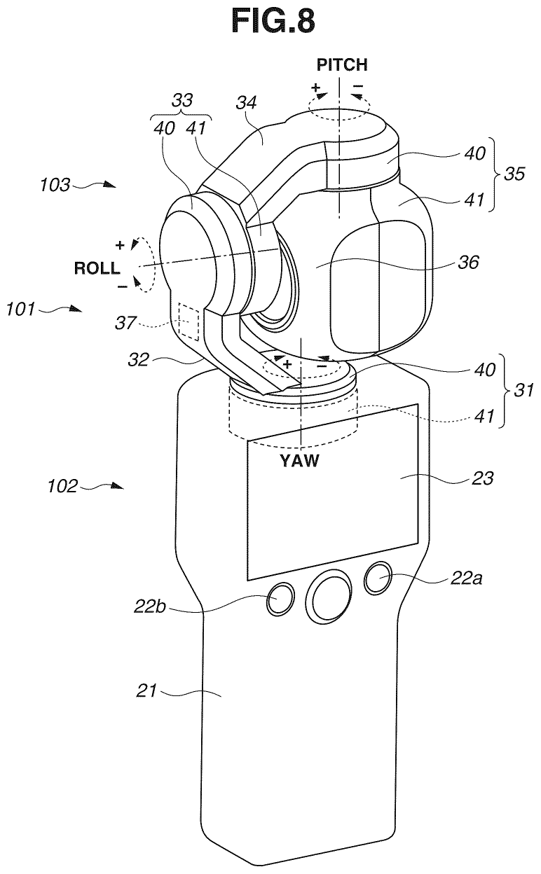

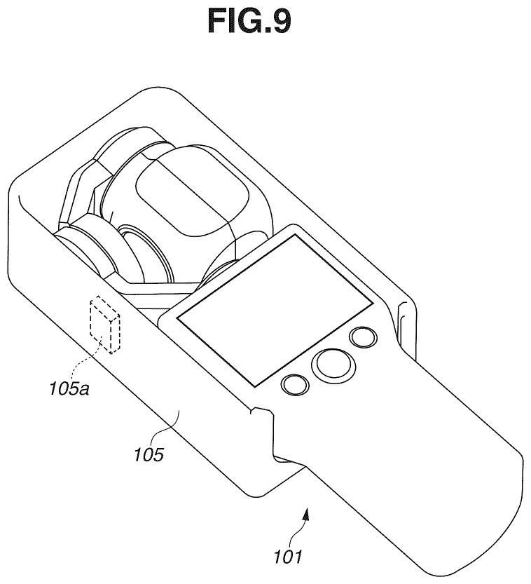

Control of a gimbal-integrated camera 101 according to a fifth embodiment will now be described. FIG. 8 is a perspective view illustrating a stored posture of the gimbal-integrated camera 101 according to the present embodiment. FIG. 9 is a perspective view illustrating a state where the gimbal-integrated camera 101 is stored in a housing case 105.

Since a basic configuration of the gimbal-integrated camera 101 is similar to that of the gimbal-integrated camera 1 according to the first embodiment, a configuration identical to that in the first embodiment is denoted by an identical reference number and a description thereof is omitted. The gimbal-integrated camera 101 is different from the gimbal-integrated camera 1 according to the first embodiment in that a magnetic detection device 37 as the non-use state determination unit 25 is provided inside the first support member 32.

The housing case 105 is used in a case where the gimbal-integrated camera 101 is carried. The housing case 105 is provided with a magnet 105a at a position facing the magnetic detection device 37 in a case where the gimbal-integrated camera 101 is stored. When the gimbal-integrated camera 101 is stored in the housing case 105, the magnetic detection device 37, which serves as the non-use state determination unit 25, approaches the magnet 105a, causing a change in the magnetic field, and this change in magnetic field can be detected. The determination of whether the gimbal-integrated camera 101 in the non-use state in step S703 in FIG. 6 is performed.

In a case where the magnetic detection device 37 provided in the gimbal-integrated camera 101 keeps detecting a change in the magnetic field caused by approaching the magnet 105a provided in the housing case 105, it is determined that the gimbal-integrated camera 101 is stored in the housing case 105. Then, it is determined that the gimbal-integrated camera 101 is in the non-use state, and a non-use state flag is set.

A method of detecting that the gimbal-integrated camera 101 is stored in the housing case 105 is not limited to the use of a magnetic detection device and a magnet. For example, it may be determined that the gimbal-integrated camera 101 is stored in the housing case 105 by using a combination of a photo-interrupter and a shielding member, or by detecting a change in luminance change.

These various kinds of detection methods are applicable.

A location where the magnetic detection device 37 is disposed in the gimbal-integrated camera 101 is also not limited to the structure of an anti-vibration mechanism 103, and the magnetic detection device 37 may be provided in a main body unit 102 or the camera unit 36. The magnetic detection device 37 may be provided at any location as long as it is in a position where it can make a determination in a case where the gimbal-integrated camera 101 is stored in the housing case 105.

According to the present embodiment, the stored posture of the gimbal-integrated camera 101 is maintained until the gimbal-integrated camera 101 is stored in the housing case 105, and the storage of the gimbal-integrated camera 101 in the housing case 105 is reliably detected.

Thereafter, by stopping the energization of the motors, it is possible to provide a gimbal-integrated camera having a simple configuration that enables further reduction in power consumption.

### Other Embodiments

The present disclosure may also be implemented by supplying a program that realizes one or more functions of the above-described embodiments to a system or apparatus via a network or a storage medium, and causing one or more processors of a computer in the system or apparatus to read and execute the program. Furthermore, the disclosure may be implemented by a circuit (e.g., an application specific integrated circuit (ASIC)) that realizes one or more functions.

The disclosure of the embodiments includes the following configurations.

### Configuration 1

An imaging apparatus comprising:
a main body;
an imaging unit;
a support unit configured to support the imaging unit;
a driving unit configured to drive the imaging unit to rotate with respect to the main body;
a memory storing instructions; and
a processor executing the instructions causing the imaging apparatus to: determine whether the imaging unit is in a non-use state;
control, in a case where termination of imaging is instructed, the driving unit to drive the imaging unit to be in a first position, and
perform control, in a case where it is determined that the imaging unit is in a non-use state, to shut off power supply.

### Configuration 2

The imaging apparatus as set forth in Configuration 1, wherein determining whether the imaging unit is in the non-use state includes detecting whether the imaging unit has been in a second position, which is different from the first position, for a predetermined period of time.

### Configuration 3

The imaging apparatus as set forth in Configuration 1 or 2, wherein, in a case where it is determined that the imaging unit is not in the non-use state, the driving unit s further controlled to drive the imaging unit to be in a third position, which is different from the first position.

### Configuration 4

The imaging apparatus as set forth in Configuration 1, further comprising an operation unit configured to be operated by a user,
wherein determining whether the imaging unit is in the non-use state is based on an operation state of the operation unit by the user.

### Configuration 5

The imaging apparatus as set forth in Configuration 4, wherein, in a case where the user performs a second operation after performing a first operation on the operation unit to instruct termination of imaging, it is determined that the imaging unit is in the non-use state.

### Configuration 6

The imaging apparatus as set forth in Configuration 5, wherein the first operation is a first operation of the operation unit, and the second operation is a second operation of the operation unit.

### Configuration 7

The imaging apparatus as set forth in Configuration 5, wherein the first operation is an operation of a first operation unit and the second operation is an operation of a second operation unit.

### Configuration 8

The imaging apparatus as set forth in Configuration 1, wherein determining whether the imaging unit is in the non-use state is based on information acquired by an image pickup element of the imaging unit.

### Configuration 9

The imaging apparatus as set forth in Configuration 1, wherein determining that the imaging unit is in the non-use state includes detecting that the imaging apparatus is stored in a housing case.

The imaging apparatus as set forth in Configuration 1, wherein determining whether the imaging unit is in the non-use state is performed after the driving unit drives the imaging unit to the first position.

According to the present disclosure, it is possible to provide a user-friendly gimbal-integrated camera.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-184711, filed Oct. 21, 2024, which is hereby incorporated by reference herein in its entirety.

What is claimed is:

1. An imaging apparatus comprising:
a main body;
an imaging unit;
a support unit configured to support the imaging unit;
a driving unit configured to drive the imaging unit to rotate with respect to the main body;
a memory storing instructions; and
a processor executing the instructions causing the imaging apparatus to:
determine whether the imaging unit is in a non-use state;
control, in a case where termination of imaging is instructed, the driving unit to drive the imaging unit to be in a first position, and
perform control, in a case where it is determined that the imaging unit is in a non-use state, to shut off power supply.

2. The imaging apparatus according to claim 1, wherein determining whether the imaging unit is in the non-use state includes detecting whether the imaging unit has been in a second position, which is different from the first position, for a predetermined period of time.

3. The imaging apparatus according to claim 1, wherein, in a case where it is determined that the imaging unit is not in the non-use state, the driving unit is further controlled to drive the imaging unit to be in a third position, which is different from the first position.

4. The imaging apparatus according to claim 1, further comprising an operation unit configured to be operated by a user,
wherein determining whether the imaging unit is in the non-use state is based on an operation state of the operation unit by the user.

5. The imaging apparatus according to claim 4, wherein, in a case where the user performs a second operation after performing a first operation on the operation unit to instruct termination of imaging, it is determined that the imaging unit is in the non-use state.

6. The imaging apparatus according to claim 5, wherein the first operation is a first operation of the operation unit and the second operation is a second operation of the operation unit.

7. The imaging apparatus according to claim 5, wherein the first operation is an operation of a first operation unit and the second operation is an operation of a second operation unit.

8. The imaging apparatus according to claim 1, wherein determining whether the imaging unit is in the non-use state is based on information acquired by an image pickup element of the imaging unit.

9. The imaging apparatus according to claim 1, wherein determining that the imaging unit is in the non-use state includes detecting that the imaging apparatus is stored in a housing case.

10. The imaging apparatus according to claim 1, wherein determining whether the imaging unit is in the non-use state is performed after the driving unit drives the imaging unit to the first position.

11. The imaging apparatus according to claim 2, wherein, in a case where it is determined that the imaging unit is not in the non-use state, the driving unit is further controlled to drive the imaging unit to be in a third position, which is different from the first position.

12. The imaging apparatus according to claim 2, further comprising an operation unit configured to be operated by a user,
wherein determining whether the imaging unit is in the non-use state is based on an operation state of the operation unit by the user.

13. The imaging apparatus according to claim 12, wherein, in a case where the user performs a second operation after performing a first operation on the operation unit to instruct termination of imaging, it is determined that the imaging unit is in the non-use state.

14. The imaging apparatus according to claim 2, wherein determining whether the imaging unit is in the non-use state is based on information acquired by an image pickup element of the imaging unit.

15. The imaging apparatus according to claim 2, wherein determining that the imaging unit is in the non-use state includes detecting that the imaging apparatus is stored in a housing case.

16. The imaging apparatus according to claim 2, wherein determining whether the imaging unit is in the non-use state is performed after the driving unit drives the imaging unit to the first position.
